(19) United States
(12) Patent Application Publication
(10) Pub. No.: US 2015/0019547 A1
(43) Pub. Date: Jan. 15, 2015

(54) UNIFIED USER PROFILES

(71) Applicants: Krishnamurthy Thalapathy, Bangalore Karnatake (IN); Paul Michael Burke, Bedford, NH (US)

(72) Inventors: Krishnamurthy Thalapathy, Bangalore Karnatake (IN); Paul Michael Burke, Bedford, NH (US)

(21) Appl. No.: 14/371,138

(22) PCT Filed: Apr. 20, 2012
(86) PCT No.: PCT/US12/34338

§ 371 Date: Jul. 8, 2014

(51) Int. Cl. G06F 17/30

(52) U.S. Cl. CPC G06F 17/30867
USPC 707/732

(57) ABSTRACT

The present disclosure is related in general to data management. Information for a single user that is stored by different entities is obtained and unified to create a unified user profile. The unified user profile is stored and can be search, displayed, and/or otherwise used. There are other embodiments as well.

### BACKGROUND

Over the last decade or so, more and more people have become subscribers of various types of services that are provided over the communication network. Often, a single network subscriber would purchase and enroll in multiple network services. Typically, service providers store user information in various types of database systems. For example, a mobile subscriber may be subscribed to both voice and cellular services offered by different mobile operators, and user profile information related to the voice and cellular services are stored at the separate database servers of the respective mobile operators. To retrieve user profile information, it is often necessary to access multiple databases where the user profiles are stored.

### BRIEF DESCRIPTION OF THE DRAWINGS

FIG. 1 is a simplified block diagram illustrating a unified user profile system.

FIG. 2A is a simplified diagram illustrating the unified user profile system 100.

FIG. 2B is a simplified block diagram illustrating functions performed by the unified user profile system 100.

FIG. 3 is a simplified block diagram illustrating unified user profile system 100 in operation.

FIG. 4 is a simplified block diagram illustrating operation of a unified user profile system.

FIG. 5 is a simplified diagram illustrating a conceptual architecture of a unified user profile system.

FIG. 6 is simplified diagram illustrating unified user profiles.

FIG. 7 is a simplified diagram illustrating relationship between unified user profile view and various data sources.

FIG. 8 is a simplified diagram illustrating an architecture that can be used for providing unified user profiles.

FIG. 9 is a simplified diagram illustrating a unified user profile.

FIG. 10 is simplified diagram illustrating a UUP system in a network environment.

### DETAILED DESCRIPTION

The present disclosure is related in general to data management. Information for a single user that is stored by different entities is gathered and unified to create a unified user profile. The unified user profile is stored and can be search, displayed, and/or otherwise used. There are other embodiments as well.

As explained above, existing solutions for storing user profiles, where a single user may have multiple profiles, typically involve storing different profiles of that single user at different databases. Consequently, to access these user profiles, it becomes necessary to individually access each of the databases where the user profiles are stored. In addition, since different databases may have different interfaces (e.g., different API's) and different database models, accessing these databases can be difficult.

Therefore, it is to be appreciated that the present disclosure describes various methods and systems for providing unified user profiles. More specifically, a Virtual Identity and Profile Broker (VIPB) is provided to create virtual views of unified user profiles. The VIPB can provide different virtual views and their mappings to various target systems. A virtual view can be a hierarchical tree structure in XML format that represents the unified user profile. By providing unified views of user profiles in the XML format, searching user profiles becomes independent of specific or custom user data models or search term syntaxes that may be required by various databases. Based on the needs, the VIPB can provide different virtual views of user profiles.

As an example, the term “VIPB” refers to a type of content management solutions (CMS) that create views of subscriber data that are mapped from multiple underlying subscriber data sources. A VIPB system can be implemented using one or more network servers and/or other entities. A virtual view can be a single XML document representing all the data of a single subscriber in the different repositories. The VIPB can be configured to perform data federation or brokering it in real-time. It can also store the assembled data tree of information for a user in an in-memory data grid. An auto-refresh process can be used to periodically trigger the VIPB to construct unified user profiles for a list of user identifiers. As the unified user profiles are collected into a cache memory, a database, and/or other types of storage, they can be indexed based on the access points (e.g. XPATH) as key and/or various attribute values that are stored in the unified profiles. For example, the indices of unified user profiles allow structured searches (e.g., using XPATH) and unstructured searches (e.g., using text).

It is to be appreciated that the methods and systems described in the present disclosure provide and manage a single view of personal, contextual, and behavioral information about a subscriber to support, thereby enhancing subscriber experiences and behaviors and promoting service providers' business interests. As an example, a unified user profile (UUP) is based on a simple premise: management of the relationship to, the experience of, and the interactions with a subscriber can be better achieved if a unified view of the subscriber and his/her information (e.g., environment, interests, devices, activities, etc.) is available to the operator and/or developer in real time.

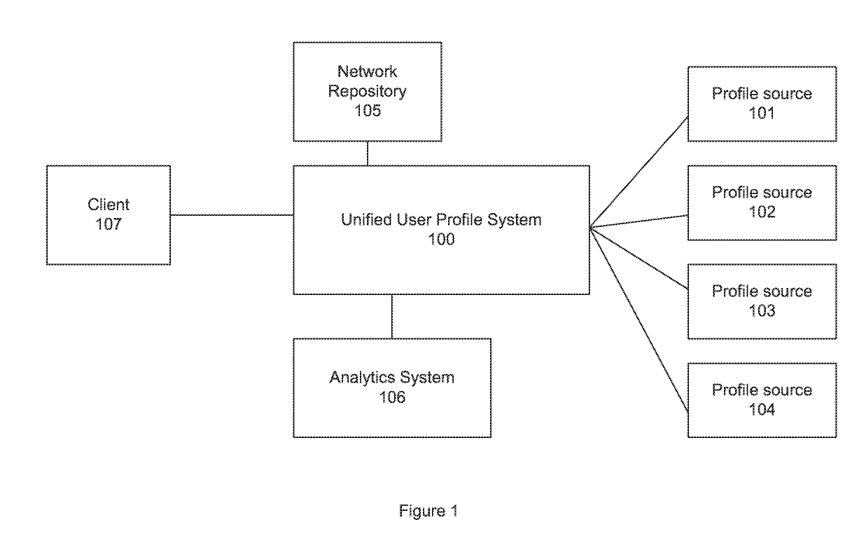

FIG. 1 is a simplified block diagram illustrating a unified user profile system. This diagram is merely an example, which should not unduly limit the scope of the claims herein. Other variations, modifications, and alternatives may be implemented. The unified user profile system 100 is configured to retrieve user profiles and information thereof from various sources. For example, the profile sources include profile sources 101-104. The profile sources can be network entities. The profile system 100 connects to the profile sources via its network communication interface(s). For example, the profile sources can be HLR systems, HSS systems, XDMS systems, NAB systems, CRM systems, billing subsystems, inventory system, trouble ticket systems, subscription system, products systems, device management systems, CDRs systems, weblog systems, IPTV log systems, cable log systems, identity management systems, location servers, presence servers, and others.

Depending on the application, the unified user profile system 100 may obtain user profiles from the profile sources in various ways. For example, the unified user profile system 100 may periodically collect user profiles from the profile sources and keeps the profiles updated. The unified user profile system 100 can also obtain user profiles from the profile sources in response to requests received from the client 107. As explained above, the unified user profile system 100 analyzes user profiles obtained from the profile sources, and multiple user profiles that are retrieved from different profile sources but related to the same user are unified into a unified user profiles. The unified user profile system 100 can generate unified user profiles in XML format, which allows for unstructured search and other ways to access. The unified user profile system 100 is connected to the network repository 105, which can be used to store unified user profiles. For example, the network repository 105 can be a webrepository, a database, an IT repository, a network repository, or others. The unified user profile system 100 as show is connected to an analytics system 106. The analytics system 106, which is described below, can performed various functions, which include consolidating user profiles, enriching user profiles with additional information, and linking user profiles to various database and services.

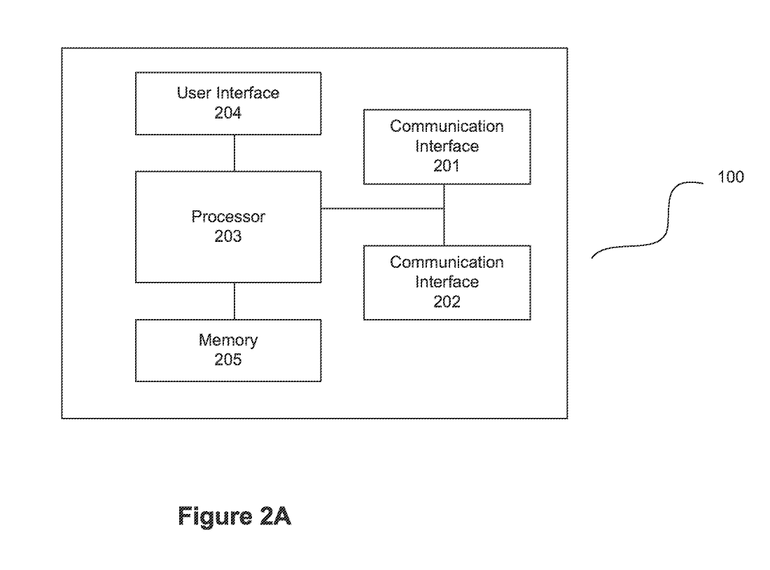

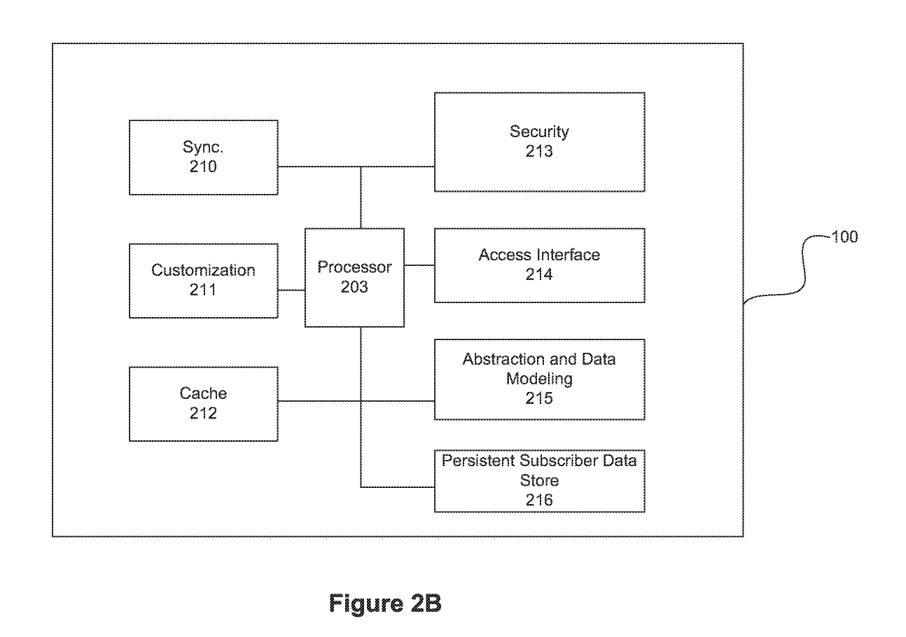

FIG. 2A is a simplified diagram illustrating the unified user profile system 100. This diagram is merely an example, which should not unduly limit the scope of the claims herein. Other variations, modifications, and alternatives may be implemented. As an example, the unified user profile system 100 comprises a user interface module 204, a processor 203, a memory 205, and communication interfaces 201 and 202. Depending on the application and specific implementation, the unified user profile system 100 may have other components as well. The processor 203 executes instructions stored at the memory 205. The memory 205, for example, can be a computer readable medium, random access memory, and other type of computer memories. Among other things, the memory 205 includes instructions for obtaining user profiles from various network entities and/or profile sources via the communication interfaces 201 and 202. The communication interfaces 201 and 202 can be local area network interface, Internet interface, wireless communication interface, power line communication interface, and/or other types of communication interfaces.

In addition, the memory 205 includes instructions for consolidating user profiles to provide unified user profiles. Once generated, unified user profiles can be stored at the memory 205 and/or external memory or database. The user interface 204 provides a way for users to access the unified user profile system 100. The user interface 204 may include a display and/or input devices such as a keyboard, mouse, touch screen, motion sensors, and/or others. For example, through the user interface 204, an operator can view the unified user profiles and/or make changes. In addition to providing unified user profiles, the unified user profile system 100 can also provide search results and/or other information. For example, the unified user profile system 100 receives a search request through the network communication interface 201, and in response the processor 203 processes the search request, accesses the unified user profiles, and generates search results.

FIG. 2B is a simplified block diagram illustrating functions performed by the unified user profile system 100. This diagram is merely an example, which should not unduly limit the scope of the claims herein. Other variations, modifications, and alternatives may be implemented. Using the processor 203, the unified user profile system 100 performs synchronization 210, customization 211, caching 212, security 213, access interfacing 214, abstraction and data modeling 215, and persistent subscriber data storage 216. As an example, one or more of these functions can be added, removed, and/or modified.

The synchronization 210 function is performed for provisioning, distributing, and synchronizing user profile data. For example, these processes can be activated by service requests and/or predetermined schedules. The customization 211 function is for customizing and configuring various controls, such as profile sources to be accessed, interval between synchronization processes, information to be collected from user profiles, and/or control parameters. The caching 212 function provides storage and/or replication of user profiles and other types of data. For example, the caching 212 function is implemented using a memory. The security 213 function sets access and security policies. When a user or a network entity accesses the unified user profile system 100, the security functions determines what level of access that user or network entity would have. For example, a unified user profile may have information that belongs to different access levels, and based on security and access policies set by the security 213 function. In addition, the security 213 function may perform authentication. The access interface 214 function provides interface between the unified user profile system 100 and other entities, such as profile sources and/or entities that need to access unified user profiles. For example, the access interface 214 function is implemented with communication interfaces that communicate with various network entities. The abstraction and data modeling 215 function analyzes the user profiles obtained from various profile sources, and based on a predetermined data model, retrieves information contained in the user profiles and generates unified profiles. For example, the abstraction and data modeling can be based on various criteria, such as profile source, name, age, purchase history, and/or others. The persistent subscriber data storage 216 function provides storage fur user profile information, and the storage can be for both unified user profiles generated by the unified user profile system 100 and user profiles obtained from various profile sources. For example, the persistent subscriber data storage 216 function is implemented using one or more storage devices, such as hard disk, solid state memory, optical disc, and/or others.

In a use scenario, a subscriber has a mobile profile stored at a mobile subscriber database and a cable television profile stored at a cable subscriber database. The mobile subscriber database and the cable subscriber database can be separate entities, and even operated by different operators. The unified user profile system 100, through its communication interfaces and with the help of the access interfacing 214 function, accesses the mobile subscriber database and the cable subscriber database to obtain the cable television profile and mobile profile. Using the predetermined criteria implemented through the abstraction and data modeling 215 function, the unified user profile system 100 generates a unified user profile for the subscriber. Depending on the application, the unified user profile can be stored in various formats, such as the XML format, which allows for unstructured searches. The unified user profile contains different levels of information, and the access of which is determined by the security 213 function. For example, the security 213 function generates an access policy for the unified user profiles, where at different access levels, different types of information stored at the unified user profile may or may not be available for access. Through the access interfacing 214 function, a searching entity may send search request to the unified user profile system 100 for mobile subscribers with certain usage patterns. Upon determining that the searching entity has the access credentials and that the subscriber meets the search criteria, the unified user profile system 100 provides the unified user profile in a unified view to the searching entity. In addition, the unified user profile system 100 may also perform analytics to help the searching entity better understand information provided in the unified user profile.

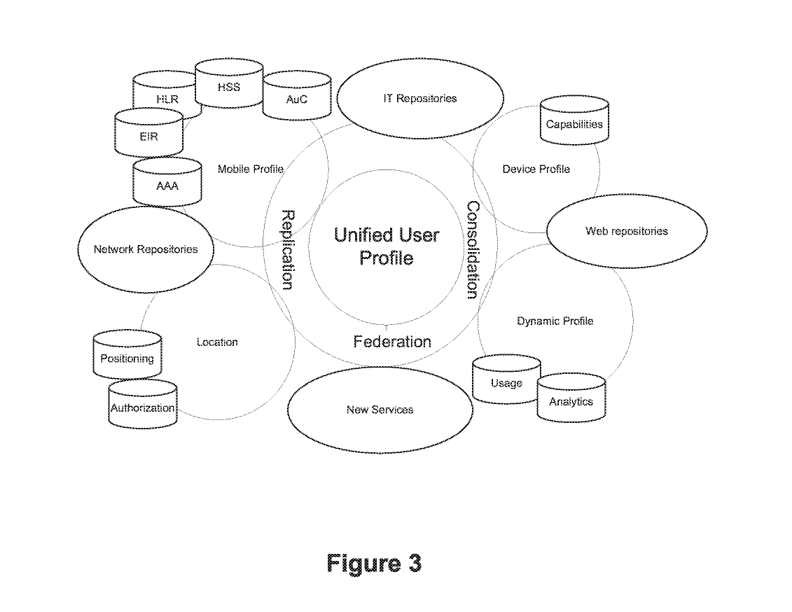

FIG. 3 is a simplified block diagram illustrating unified user profile system 100 in operation. This diagram is merely an example, which should not unduly limit the scope of the claims herein. Other variations, modifications, and alternatives may be implemented. As illustrated in FIG. 3, a unified user profile system provides consolidation, federation, and replication user profile data. The unified user profile system obtains and consolidates user profiles from mobile profile sources, device profile sources, and/or other sources where user profiles are stored. For example, the mobile profiles can be stored at network repositories and IT repositories. Web repositories may store user profiles as well. The unified user profile system 100 accesses these repositories and obtain user profiles stored therein.

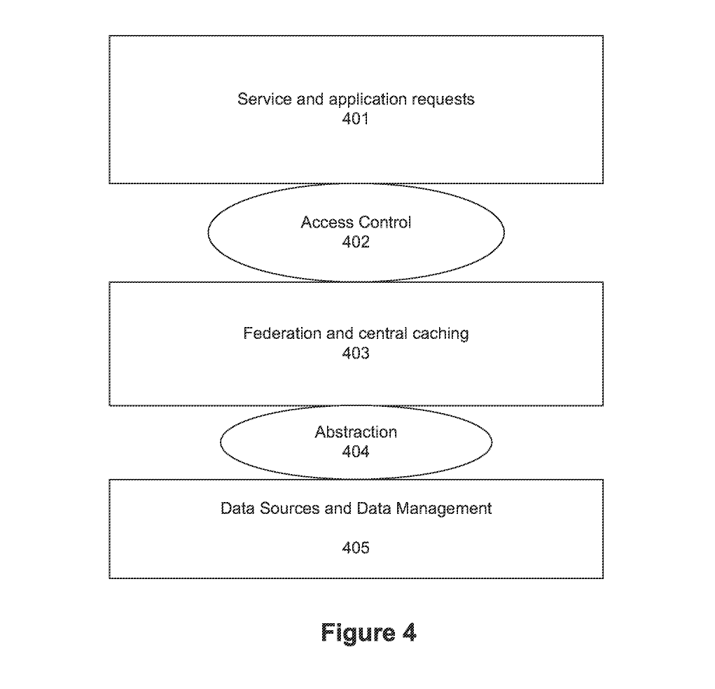

FIG. 4 is a simplified block diagram illustrating operation of a unified user profile system. This diagram is merely an example, which should not unduly limit the scope of the claims herein. Other variations, modifications, and alternatives may be implemented. User profiles are stored ate various data sources and data management 405. For example, the data sources can be independent and separate from one another. Through the federation and central caching 403 function, data sources are accessed using protocols and identification information that are native to the database where user profiles are stored. Once user profiles are obtained, abstraction 404 is performed. For example, through abstraction 404, user profiles are unified become searchable in adaptive format. Various entities and services, such as local network, IT services, web entities, new services, may send service and application request at block 401 access unified user profiles. For example, the requests are in the form of query data in adaptive format (e.g., XML, LDAP), with one or more user IDs that are known requesting entities arid/or entities where user profiles are stored. The access control 402 determines the ability and credential of the requesting entity to access data.

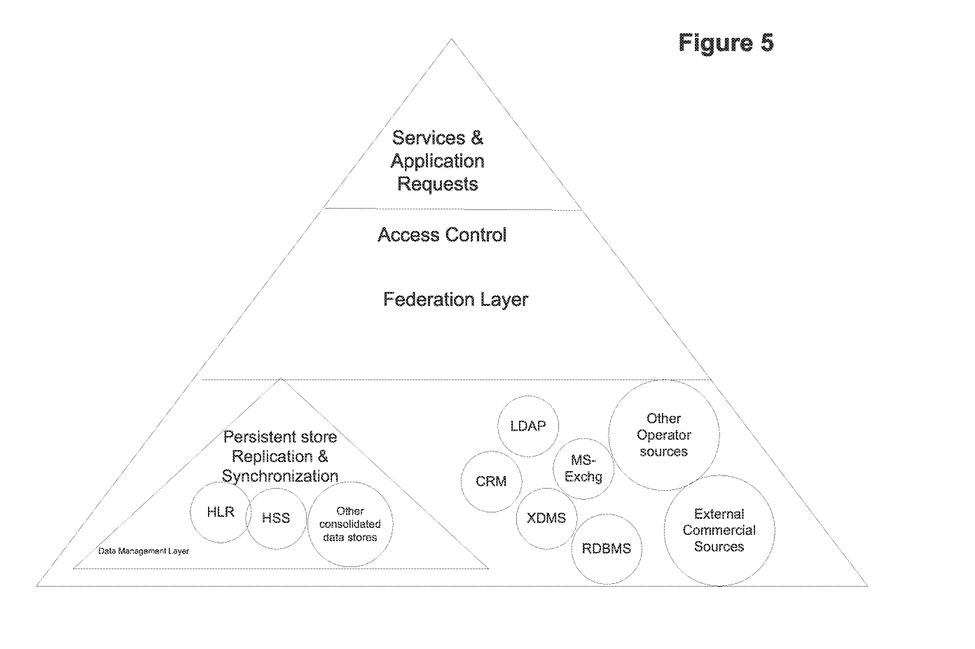

FIG. 5 is a simplified diagram illustrating a conceptual architecture of a unified user profile system. This diagram is merely an example, which should not unduly limit the scope of the claims herein. Other variations, modifications, and alternatives may be implemented. A UUP provides both a federation layer, as well as a data repository layer along with synchronization capabilities. This means that service providers can leverage data stored in silos via a federated architecture. That is, user profile data are accessible from a unified point, even though individual user profiles may continue to reside in their respective data silos. It is to be appreciated that the architecture as shown in FIG. 5 provides different types of applications, whether internal or external, with immediate single-source, single protocol, and single transaction access unified user profile data that were once dispersed. In a way, migration or consolidation is not required to take advantage of available user profile data, thereby allowing operators to move forward quickly with application initiatives that leverage profile data. In addition, with the architecture illustrated in FIG. 5, operators can undertake complex, expansive, and long-running consolidation initiatives on reasonable time schedules.

To make unified user profile data usable and assessable, adaptive formats can be used. For example, adaptive formats such as XML and LDAP formats are supported in the federation layer. Data presented to applications are abstracted. Being dissociated from physical storage location, structure, access protocol, and identity, abstract data make it possible for applications to approach the UUP with a known identity via an XML or LDAP request, and that identity is translated to every other identity and protocol needed to get the data. For example, the UUP system is capable of communicating using many different types of communication protocols.

The unified user profile system also provides an identity aliasing feature that enables an application to use the identity it knows the subscriber as, even though multiple identities may be required to access data across different sources where subscriber profiles are stored.

The federation can be configured to support “virtual” data models, which is to overcome the issues that may be caused by trying to create a monolithic data model. This means that any set or subset of data can be presented to any application, or group of applications, independent of all other applications and groups. Since data models can be created and evolved independently, each application initiative could even have its own data model. This is useful in limiting the access of external developers to only those elements of the data model the operator wishes that application to see, which provides a security benefit.

Fine-grained Access Control Lists (ACL) system is used to provide release control down to the by-element, by-requestor, by target subscriber level, which is consistent with the emerging OMA Global Permissions Manager standard. In addition to this security, group-level controls can also be supported, both for user-defined groups (e.g., membership and privileges) and global operator groups.

The UUP can have a multi-level cache capability, with caches at the federation as well as the data repository levels. Caching at the federation layer enables repeatability and consistency with regard to high performance, and it provides sophisticated control mechanisms to enable search requestors to use data within, or beyond, its time to live, to force a cache refresh for given elements or sources, and the like.

The data management layer provides central provisioning, control, and management of persistent data, thereby enabling the creation of a master repository or a central cache. Data replication capabilities from the data management layer enable central provisioning and support master data management initiatives.

In addition, the UUP can provide data transformation between the virtual view and the physical layer, both outbound and inbound. Data transformation can be used for lowering the resolution of a location, depending on who made the request (outbound). Data transformation can also be sued for data encryption (both inbound and outbound).

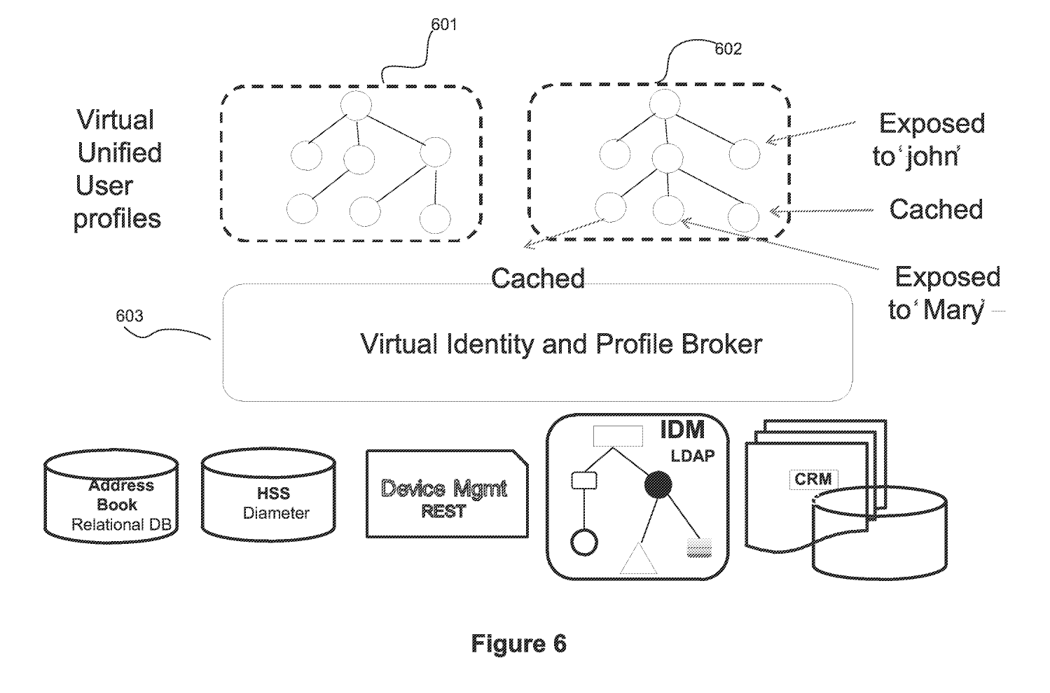

FIG. 6 is simplified diagram illustrating unified user profiles. This diagram is merely an example, which should not unduly limit the scope of the claims herein. Other variations, modifications, and alternatives may be implemented. Unified user profiles as shown can be stored as virtual unified user profiles that are optimized for various types of viewing. For example, a unified user profile may have multiple virtual views, each of which being prepared for a specific viewing need (e.g., certain information being visible only in certain virtual views). The VIPB 603 acts as an intermediary between the unified user profiles and varies data sources and network entities. For example, the VIPB 603 obtains user profiles from data sources such as relational database, Diameter database (e.g., database for storing billing information), and/or other sources. Upon processing and abstracting information from the user profiles, the VIPB 603 generates unified user profiles. For example, the VIPB generates unified user profiles 601 and 602, which can be stored in an XML format that is convenient for later access. The unified user profiles, once generated, can be stored at cache memory and/or a long-term storage entity. The unified user profile 602 as shown comprises different levels of information, and some and/or all of the information is stored at a cache memory. For example, different levels of information correspond to different access level as governed by the predetermined access policies. When an entity, such as CRM Web Service, tries to obtain unified user profile information through the VIPB, information available or visible to that entity depends on the access policy. For example, one set of information is exposed only to “John” and another set of information is only exposed to “Mary”. To making searching and retrieving information from the unified user profiles easy, the unified user profiles are stored in a format (e.g., VAL or others) that allows for unstructured search. For example, regardless of the data model used for creating the unified user profile, unified user profiles can be searched using unstructured search terms. As shown in FIG. 6, the unified user profiles 601 and 602 are stored in tree structures, which allows for performing parallel query to multiple sources based on metadata and identity aliasing.

Depending on the application, the virtual unified user profiles can be configured for different viewing options. Each unified user profile can be presented as a single subscriber view. To access any of the unified user profile, a single point of access is provided through the VIPB 603. The unified user profiles can be stored in a common data model, which allows for unified and convenient methods of access. The access policies provide privacy control that prevents unauthorized access to user profile information. Based on the viewing needs, virtual views for unified user profiles can be modified.

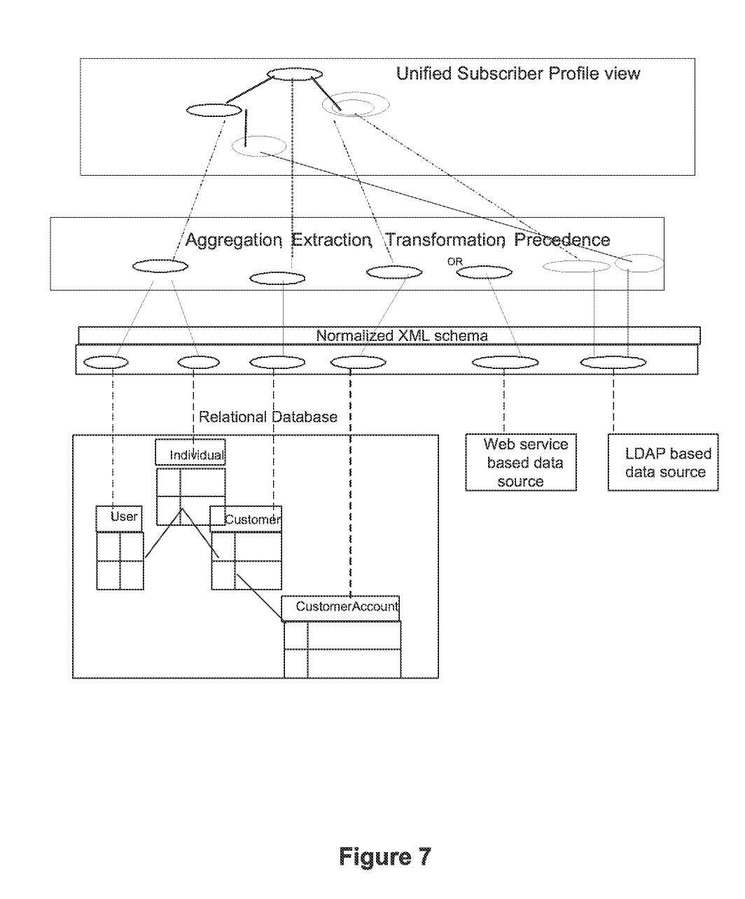

FIG. 7 is a simplified diagram illustrating relationship between unified user profile view and various data sources. This diagram is merely an example, which should not unduly limit the scope of the claims herein. Other variations, modifications, and alternatives may be implemented. As shown in FIG. 7, a unified data source may have information stored at different data nodes. Each of the data nodes of the unified user profile may correspond to one or more user profiles that are stored in data sources, and information for each data node is obtained through aggregation, extraction, transformation, and/or precedence processes.

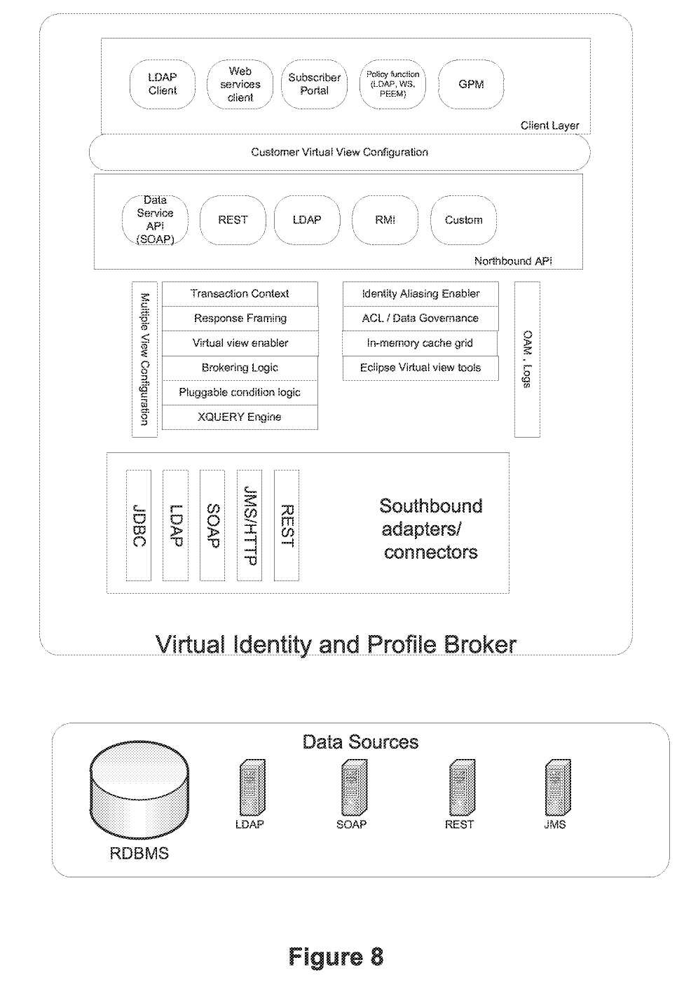

FIG. 8 is a simplified diagram illustrating an architecture that can be used for providing unified user profiles. This diagram is merely an example, which should not unduly limit the scope of the claims herein. Other variations, modifications, and alternatives may be implemented. As shown in FIG. 8, the architecture can be divided into a client layer, a federation layer, and a data management layer.

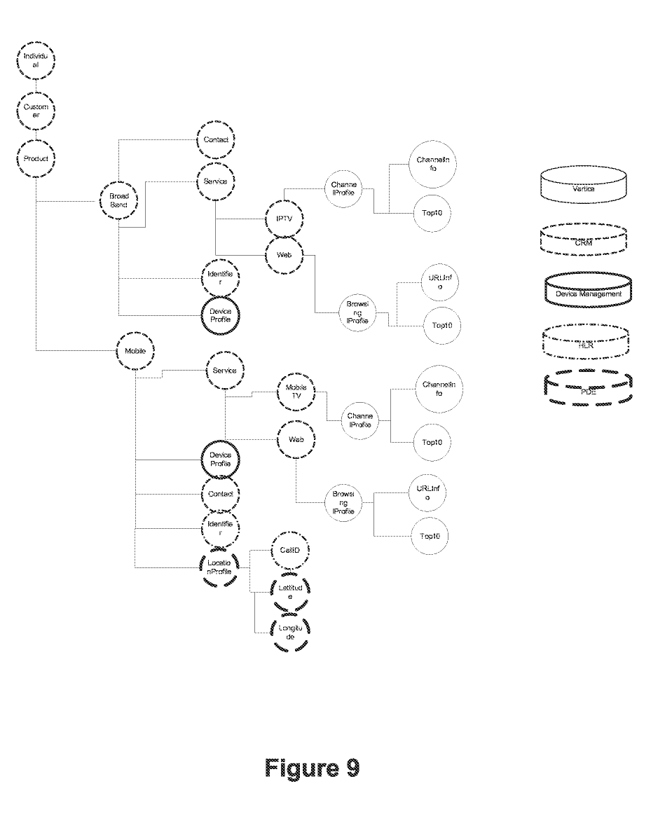

FIG. 9 is a simplified diagram illustrating a unified user profile. This diagram is merely an example, which should not unduly limit the scope of the claims. Other variations, modifications, and alternatives may be implemented. For example, the unified user profile in FIG. 9 is stored in an XML format. The user data in Vertica database is mapped to the logical data model objects Channel Profile and BrowsingProfile, both are under the logical data views of Mobile and Broadband Service of a single user (i.e., “Individual” node). For example, these data model objects denote the channels watched and web sites browsed by the user and Top10 interests of the user. Similarly, the profile source PDE has location information that is mapped to the logical data view of LocationProfile, Lattitude, and Longitude.

Once a logical XML view is available, the VIPB provides data federation and unification, which can be a part of a CMS system. It is to be appreciated the logical XML view allows reading of any part of the unified user profile, which can be a logical data view, with any of the user's known identifier (e.g., email, MSISDN, etc). The VIPB is internally configured to map the parts of the logical data model to the different data sources using XML and XQUERY based configuration. When a read request is triggered on any part of the logical data model, the VIPB access the data model and in parallel retrieves different data required to form a unified user profile using the corresponding transformations and identifiers necessary to retrieve data from different data source, thereby fulfilling the read request. For example, if Individual/Customer/Product/Broadband is read for a user with the identifier “MSISDN 1234567890”, three data sources (e.g., CRM, Device Management, and Vertica) are read. During the read process, different identifiers may be needed to access different data sources. There can be multiple identifiers of the same type. For example, the CRM data source may need a Customer ID that is not the same as MSISDN. Internally, the VIPB provides a linkage of the different identifiers of a single user from a given identifier,

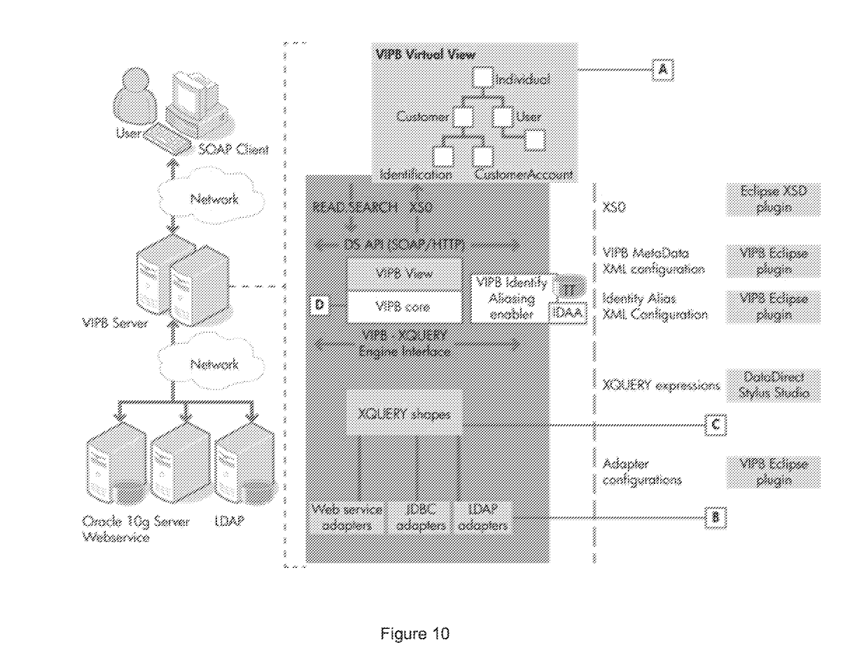

FIG. 10 is simplified diagram illustrating a UUP system in a network environment. This diagram is merely an example, which should not unduly limit the scope of the claims. Other variations, modifications, and alternatives may be implemented. As shown in FIG. 10, a VIPB server provides search services and other accesses to a user through network. The VIPB is also connected various servers, including the Oracle 10g and LDAP servers, through network. The VIPB uses a data model to organize and store user profile information, which may be accessed and searched as shown.

One of the benefits from aggregating and organizing user profiles into a unified user profile, which can be stored in an XML format, is user data can be accessed and search using one of many identifiers of a single user.

When an external process (or application) that triggers the access of unified user profile, for every user based on a given list of identifiers is run periodically and the federated XML profiles are cached in a time-to-live in-memory cache grid which spans clusters of nodes. Once user profiles are obtained from various profile sources, they may be stored in a cache memory for easy access. For easy access, the UUP system may index various values of the user profiles against the XPATHs of the unified XML For example, the indices can be stored in cache memory, thereby making it accessible across the different nodes.

Now referring to FIG. 9 to provide an example. A user identified by “MSISDN 1234567890” may have Discovery Channel and National Geographic as his Top10 channels watched. This information is federated from Vertica and unified into a single user profile XML. These values of Discovery and National Geographic are indexed against the XPATH of Individual/Customer/Product/Broadband/Service/IPTV/ChannelProfile/Top10. Similarly the age and gender, which are attributes of the /Individual (not shown in FIG. 9), are indexed with the values of “45” and “Male” as retrieved from the CRM system. The indices created against the XPATH of the unified profile of a user are maintained in a single document, which can be stored in an in-memory cache grid.

When a search request is issued by a client application, the indices are used to find the match. For example, a search request that includes “find all users whose Top10 interests have Discovery Channel and whose age falls between 35 and 45 and who are Male” and “return their Mobile phone numbers”, a search function uses the indices created against the XPATH to find the matching documents that met these search terms. The client application may further narrow down the search by issuing a command that is as part of the search request to return desired attributes. For example, the client application issues a “return” command to provide the MSISDN attribute, which causes the UUP system to return all the MSISDNs of the users who matched the search criteria based on index values of their ULT. In turn, a “read” command is issued on the desired XPATHs of the ‘identifiers’ of the matched documents. Depending on the application, each of the indices can also store one of the identifiers of a user so that the index can be further used to retrieve the other information and attributes.

TABLE 1

| Data | Type | Query | Syntax |
|---|---|---|---|
| (relatively) | Boolean | Search all users who | SEARCH /Individual/Customer/Product/Mobile/DeviceProfile/DeviceModel:iPhone AND |
| Static | combination | has an iPhone and | /Individual/Customer/Product/Mobile/Contact/City: Bangalore |
| attributes | in match | live in Bangalore | |
| | criteria | | |
| | Regular | Same as above | SEARCH /Individual/Customer/Product/Mobile/DeviceProfile/DeviceModel:*iPhone* AND |
| | expression | | /Individual/Customer/Product/Mobile/Contact/City: Bangalore |
| | match | | |
| | Range match | Search all male users | SEARCH /Individual/gender: males AND /Individual/age:[30 TO 35] |
| | | whose age is | |
| | | between 30 and 35 | |
| | Return result | Search all users who | SEARCH /Individual/Customer/Contact/City:NewYork AND |
| | | live in New York | /Individual/Customer/Product/Broadband/Service/IPTV/Status:Active AND |
| | | having both IPTV and | /Individual/Customer/Product/Mobile/Service/IPTV/Status:Active |
| | | mobile TV | RETURN |
| | | subscription and | Rule = Response |
| | | return their locality | ParamName = xpath |
| | | and age | ParamValue = /Individual/Contact/Locality |
| | | | ParamName = xpath |
| | | | ParamValue = /Individual/age |
| | Rules | How many users who | SEARCH /Individual/Customer/Product/Mobile/DeviceProfile/DeviceModel:iPhone AND |
| | triggering | has an iPhone and | /Individual/Customer/Product/Mobile/Contact/City: Bangalore |
| | extra logic | live in Bangalore | RETURN |
| | on returned | | Rule = CountRecords |
| | response | | |
| | Rules | What is the average | SEARCH /Individual/Customer/Contact/City:NewYork AND |
| | triggering | age of users owning | /Individual/Customer/Product/Mobile/Service/IPTV/Status:Active |
| | extra logic | an iPhone who has | RETURN |
| | on returned | subscribed for | Rule = Average |
| | response | MobileTV in New | ParamName = field |
| | | York | ParamValue = /Individual/age |
| Dynamic | Query on | How many users | SEARCH |
| attributes | dynamic raw | visited CNN.com who | /Individual/Customer/Product/Mobile/Service/Web/BrowsingProfile/URLInfo/URL:CNN.com |
| (Raw data | data - very | lives in Bangalore in | AND /Individual/Customer/Product/Mobile/Contact/City: Bangalore |
| URLs) | recent | the last 24 hours | RETURN |
| | Multiple | | Rule = CountRecords |
| | rules | | Rule = Timeline |
| | | | ParamName = past |
| | | | ParamValue = 24Hr |
| | Query on | Search all male users | SEARCH |
| | dynamic raw | who visited CNN.com | /Individual/Customer/Product/Mobile/Service/Web/BrowsingProfile/URLInfo/URL:CNN.com |
| | data - not so | in the last 1 month | AND /Individual/Customer/Product/Mobile/Contact/City: Bangalore |
| | recent | whose age is | RETURN |
| | | between 30-40 | Rule = Timeline |
| | | | ParamName = past |
| | | | ParamValue = 1Month |
| Dynamic | Query on | How many people | SEARCH |
| attributes | dynamic | whose recent | (/Individual/Customer/Product/Mobile/Service/Web/BrowsingProfile/Top10:*cricket* OR |
| (Analyzed | analyzed | interests show | /Individual/Customer/Product/Broadband/Service/Web/BrowsingProfile/Top10:*cricket*) |
| data) | data - very | ‘Cricket’ at the top of | AND Individual/Customer/Product/Mobile/Service/Status:Active AND |
| | recent | the Top10 interests, | /Individual/Customer/Product/Mobile/Contact/City: Bangalore |
| | | has a mobile | RETURN |
| | | subscription and live | Rule = CountRecords |
| | | in Bangalore? | Rule = Timeline |
| | | | ParamName = past |
| | | | ParamValue = 24Hr |
| | Query on | What are the other | SEARCH |
| | dynamic | interests of users | /Individual/Customer/Product/Mobile/Service/Web/BrowsingProfile/Top10:*Thai Veg Curry* |
| | analyzed | interested in ‘Thai | RETURN |
| | data - Rec- | Vegetable Curry’ in | Rule = DistributeDescending |
| | ommendations | descending order of | ParamName = xpath |
| | | scores | ParamValue = /Individual/Customer/Product/Mobile/Service/Web/BrowsingProfile/Top10 |

Table 1 provides an example of various types of search terms that can be used to at an UUP system. This table merely provides an example, which should not unduly limit the scope of the claims herein. One of ordinary skill in the art would recognize other variations, modifications, and alternatives.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for managing user information, the method comprising:
providing a profile module, the profile module comprising a processor and a first communication interface and a second communication interface;
identifying a first subscriber;
interfacing with a first server through the first communication interface;
obtaining a first user profile associated with the first subscriber from the first server;
interfacing with a second server through the second communication interface;
locating a second user profile stored on the second server, the second user profile being associated with the first subscriber;
obtaining the second user profile from the second server;
processing the first user profile;
providing a first set of information from the first user profile;
processing the second user profile;
providing a second set of information from the second user profile;
generating a unified view for the first subscriber, the unified view comprises information from the first set of information and the second set of information; and
storing the unified view at a memory module.

2. The method of claim 1 further comprising:
receiving a search request related to the first subscriber;
processing the search request;
generating a search result based on information from the unified view in response to the search request.

3. The method of claim 2 wherein the search request comprises an XML or LDAP request.

4. The method of claim 1 wherein the unified view is in an adaptive format.

5. The method of claim 1 further comprising:
obtaining a third user profile;
updating the unified view based at least on the third user profile.

6. The method of claim 1 further comprising:
determining a change for the first user profile;
updating the unified view in response to the change.

7. The method of claim 1 further comprising performing analytics using at least the unified view.

8. The method of claim 1 further comprising updating the unified view at a predetermined time.

9. The method of claim 1 wherein the first user profile is associated with a mobile phone subscription plan.

10. A method for providing subscriber information, the method comprising;
providing a profile system, the profile system comprises a plurality of communication interfaces and processor;
selecting a first user;
forming connections between the plurality of communication interfaces and a plurality of data sources, the plurality of data sources comprising user profiles associated with the first user;
obtaining at least a first profile and a second profile associated with the first user;
processing the first profile and the second profile;
retrieving user information from the first profile and the second profile;
creating a unified view for the first user, the unified view comprising the user information;
determining a plurality of access levels for the user information;
generating an access policy based at least on the plurality of access levels;
receiving a query related to the first user; and
generating response information using the unified view in accordance with the access policy.

11. The method of claim 10 further comprising:
generating an index associated with the unified view for the first user, the index comprising the user information;
establishing a communication interface between the profile system and a network entity;
authenticating the network entity;
wherein the query is received from the network entity.

12. A method for providing subscriber information, the method comprising:
providing a profile system, the profile system comprising a processor and a computer readable medium and one or more communication interfaces, the processor being configured to execute codes at the computer readable medium;
obtaining a plurality of user profiles from a plurality of sources via the one or more communication interfaces;
associating the plurality of user profiles to a plurality of users, the plurality of users including a first user, the first user being associated with two or more user profiles;
generating unified profiles, each of the unified profiles being associated with a user and comprising information from the plurality of user profiles;
analyzing the unified profiles;
providing access policies for the unified profiles;
receiving a search request from a network entity via one of the communication interfaces, the search request comprising one or more search criteria;
determining an access level for the search requests based at least on the access policies by the processor;
accessing unified profiles in response to the search request in accordance to the access level;
retrieving result information from the unified profiles based at least on the one or more search criteria; and
generating a search result, the search result comprising the result information.

13. The method of claim 12 further comprising performing analytics for the unified user profiles.

14. The method of claim 12 further comprising consolidating the plurality of user profiles.

15. The method of claim 12 further comprising storing the unified profiles.
